(19) United States
(12) Patent Application Publication
(10) Pub. No.: US 2008/0011610 A1
(43) Pub. Date: Jan. 17, 2008

(54) Plating method

(75) Inventors: Masaya Katou, Kawasaki (JP); Mutsuo Yoshinami, Kawasaki (JP); Yasunori Kouchi, Kawasaki (JP); Mamoru Tsuruta, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/585,091

(22) Filed: Oct. 24, 2006

(30) Foreign Application Priority Data
Jun. 30, 2006 (JP) 2006-181010

(51) Int. Cl. B05D 3/04; C25D 5/02; B05D 3/10

(52) U.S. Cl. 205/118; 427/304

(57) ABSTRACT

Electrolytic plating can be carried out with a uniform thickness even when the resistance of a plating seed layer is comparatively high, thereby improving the formation precision of products and improving the yield of products. In a method of carrying out plating on a substrate, an insulating layer, which includes conductive parts that conduct electricity to the substrate, is formed on the substrate that is made of a resistor, a plating seed layer, which conducts electricity to the substrate via the conductive parts, is formed on the insulating layer, and a plating film is formed on the plating seed layer with the plating seed layer as a power supply layer.

### BACKGROUND OF THE INVENTION

1. Field of the Invention

The present invention relates to a plating method and in more detail to a method of carrying out plating using a plating seed layer during the manufacturing process of a magnetic head or the like.

2. Related Art

A magnetic head is formed by forming and patterning layers, such as a magnetic layer and an insulating layer, on top of one another on the surface of a work composed of a ceramic substrate (an Al₂O₃—TiO substrate). A method such as electrolytic plating or sputtering is used as the method of forming the magnetic layer and the like, with electrolytic plating being commonly used when forming and patterning a conductive layer such as a magnetic layer. Electrolytic plating is not limited to the manufacturing of a magnetic head, and is also commonly used when forming a wiring pattern during the manufacturing process of a wiring substrate such as a resin substrate.

When forming a conductive layer such as a magnetic layer or a copper layer by electrolytic plating, there is a method that first forms a plating seed layer on the surface of the work and then forms the magnetic layer or the copper layer on the surface of the plating seed layer with the plating seed layer as a power supply layer.

FIG. 6 is a schematic diagram showing a plating method where a plating seed layer 12 is provided on the surface of a substrate 10 and then plating is carried out on the surface of a work 20 by electrolytic plating. That is, the work 20 is immersed in an electrolysis tank filled with electroplating solution, plating contacts of a negative electrode 30 are placed in contact with the plating seed layer 12 formed on the surface of the work 20, and plating is carried out by applying an electric field between a positive electrode 40 disposed facing the work 20 and the negative electrode 30.

### Patent Document 1

Japanese Laid-Open Patent Publication No. S59-23892

### Patent Document 2

Japanese Laid-Open Patent Publication No. 2005-171307

### SUMMARY OF THE INVENTION

A magnetic head or a wiring substrate is formed by interposing an insulating layer between a magnetic layer and a conductive layer to electrically insulate the magnetic layer and the conductive layer from one another. Accordingly, a plating seed layer is normally electrically insulated from a substrate. FIG. 6 is useful in showing a state where an insulating layer 14 has been formed between a substrate 10 and the plating seed layer 12.

When carrying out electrolytic plating using the plating seed layer 12, although it is not such a problem if the electrical resistance of the plating seed layer 12 is low, if the seed resistance of the plating seed layer 12 is large such as when the plating seed layer 12 is formed of a magnetic material such as iron or cobalt, a potential difference is produced across the plating seed layer 12 itself, resulting in the problem of the thickness of the plating becoming non-uniform across the surface of the work 20.

FIG. 6 shows a state where there are fluctuations in the potential at the surface of the plating seed layer 12 so that the thickness of the plating on the surface of the work 20 at positions close to the plating contacts 30a of the negative electrode 30 is large and the thickness of the plating at the center of the work 20 distant from the plating contacts 30a is small. Such fluctuations in the thickness of the plating on the surface of the plating seed layer 12 lead to problems of lower precision for products and a lower manufacturing yield, and therefore pose a major problem for the manufacturing of products such as magnetic heads where high precision is required.

Also, as shown in FIG. 6, since the plating contacts of the negative electrode 30 are placed in contact with the plating seed layer 12 formed on the surface of the work 20 and electricity is conducted via the plating seed layer 12 and the negative electrode 30, it is necessary to provide a region on the surface of the work 20 (for example, at the edge of the work 20) to which the plating contacts can be placed in contact. This means that the effective area of the work 20 that can be used to manufacture products is reduced.

The present invention was conceived to solve the problems described above and relates to a plating method that uses a plating seed layer and can carry out plating with a uniform thickness even when the resistance of the plating seed layer is comparatively high. Such plating method increases the formation precision of products, increases the manufacturing yield of products, and can also increase the area of a work that is used effectively.

To achieve the stated object, a method of carrying out plating on a substrate according to the present invention includes steps of: forming an insulating layer, which includes conductive parts that conduct electricity to the substrate, on the substrate that is made of a resistor; forming a plating seed layer, which conducts electricity to the substrate via the conductive parts, on the insulating layer; and forming a plating film on the plating seed layer with the plating seed layer as a power supply layer.

A conductive layer may be formed in a pattern on the substrate to form the conductive parts and the insulating layer may be selectively formed on the conductive pattern.

Also, by carrying out plating by placing a plating contact of a negative electrode in contact with a rear surface of the substrate, it becomes possible to use the entire region of a work as a region for forming products.

Also, by forming the conductive parts corresponding to formation regions of products formed on a work, fluctuations in the potential of the plating seed layer during plating are suppressed, so that the thickness in the plating can be formed uniformly. Note that the expression “forming the conductive parts corresponding to formation regions of products” includes a case where one or a plurality of conductive parts are formed per individual formation region and a case where one or a plurality of conductive parts are formed per group of a plurality of individual formation regions.

Another method of carrying out plating on a substrate according to the present invention includes steps of: forming an insulating layer, which includes conductive parts that conduct electricity to a resistor layer formed on a surface of an insulating substrate, on the insulating substrate; forming a plating seed layer, which conducts electricity to the resistor layer via the conductive parts, on the insulating layer; and forming a plating film on the plating seed layer with the plating seed layer as a power supply layer.

With the plating method according to the present invention, even when the specific resistance of the plating seed layer is comparatively high, by having electricity conducted via the conductive parts between the plating seed layer and the substrate composed of a resistor or by having electricity conducted via the conductive parts between the plating seed layer and a resistor layer provided on the surface of the substrate, it is possible to suppress fluctuations in the potential of the plating seed layer and to make the thickness of the plating uniform. By doing so, it is possible to form conductive parts and the like on a substrate with high precision and to improve the manufacturing yield of products.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a schematic diagram of a plating method according to a first embodiment of the present invention;

FIG. 2 is a diagram useful in explaining a state where conductive parts have been formed on a substrate;

FIGS. 3A to 3E are diagrams useful in explaining a process that carries out plating on a substrate using the plating method according to the present invention;

FIG. 4 is a schematic diagram showing another example of a plating method;

FIG. 5 is a schematic diagram showing a plating method according to a second embodiment of the present invention; and

FIG. 6 is a schematic diagram showing a conventional plating method.

### DESCRIPTION OF THE PREFERRED EMBODIMENTS

Preferred embodiments of a plating method according to the present invention will now be described in detail with reference to the attached drawings.

### First Embodiment

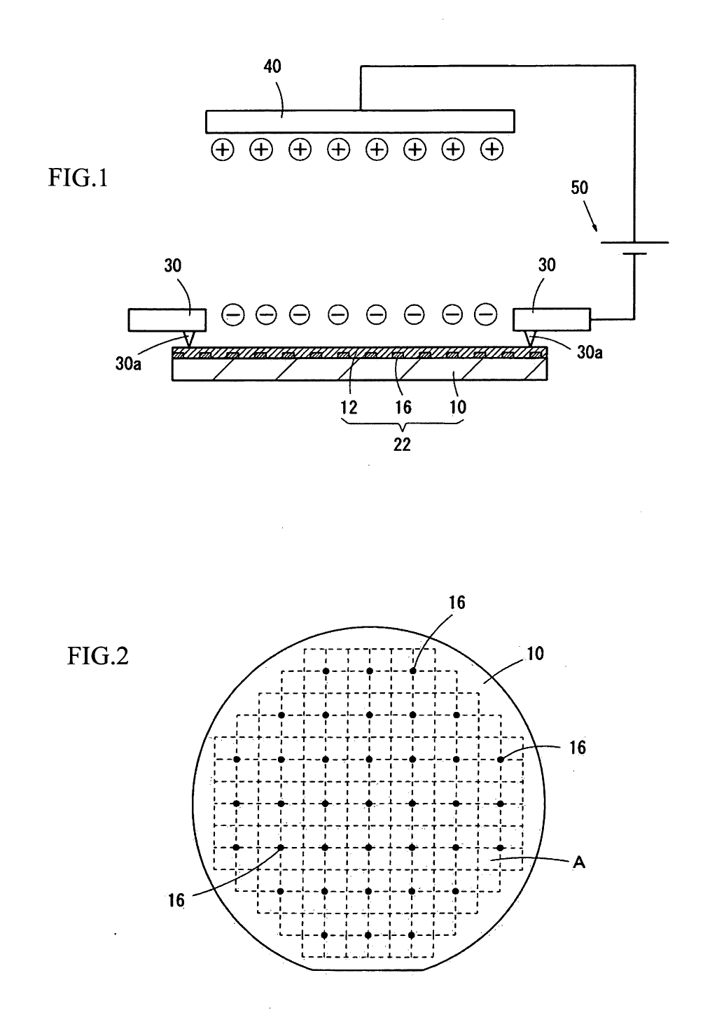

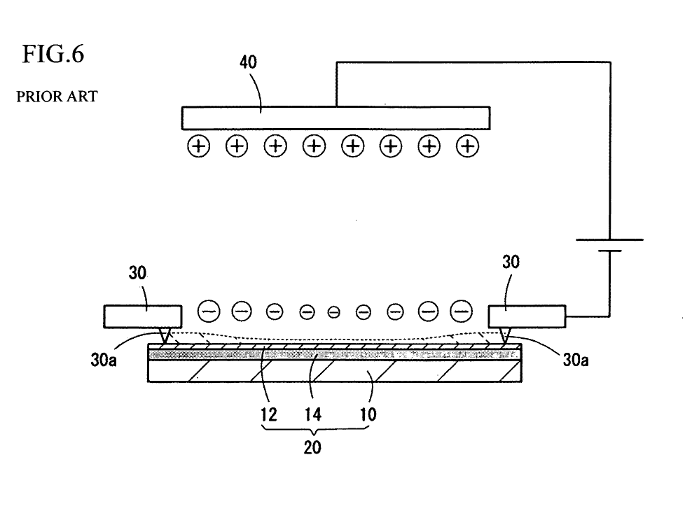

The plating method shown in FIG. 1 has the same apparatus construction as the conventional plating method shown in FIG. 6. That is, the apparatus includes a negative electrode 30 equipped with plating contacts 30a that are placed in contact with the plating seed layer 12 provided on the surface of the substrate 10, a positive electrode 40 disposed facing a work 22, and a power supply 50.

The plating method according to the present embodiment is characterized by the construction of the plating seed layer 12 on the substrate 10. That is, although the plating seed layer 12 formed on the work 20 is formed so as to be electrically insulated from the substrate 10 of the work 20 in the conventional plating method shown in FIG. 6, with the present embodiment, the plating seed layer 12 is constructed so as to actively conduct electricity to the substrate 10.

FIG. 1 shows the overall construction of the work 22 and shows how conductive parts 16 are uniformly distributed across the surface of the substrate 10 so as to conduct electricity between the plating seed layer 12 and the substrate 10 and how the plating seed layer 12 is provided so as to conduct electricity to the conductive parts 16.

In this way, by electrically connecting the plating seed layer 12 to the substrate 10 via the conductive parts 16 and forming the substrate 10 from a resistor with comparatively low resistance, it becomes possible for electricity to be conducted to the plating seed layer 12 via the substrate 10 and the conductive parts 16. Accordingly, when the plating contacts 30a are placed in contact with the plating seed layer 12 and electrolytic plating is carried out, the entire plating seed layer 12 reaches the same potential, and therefore it is possible to make the thickness of the plating formed on the surface of the plating seed layer 12 uniform.

That is, with the plating method according to the present embodiment, by electrically connecting the plating seed layer 12 to the negative electrode 30 via the substrate 10 and the conductive parts 16, it becomes possible to effectively lower the seed resistance of the plating seed layer 12. By doing so, during plating there is a reduction in the fluctuations in potential at the surface of the plating seed layer 12 and a reduction in the fluctuations of the plating thickness.

In the present embodiment, the substrate 10 needs to be a conductor so that electricity can be conducted to the plating seed layer 12 via the substrate 10 and the conductive parts 16. However, since the substrate 10 is much thicker than the conductive layer formed by plating, the substrate 10 only needs to have a certain degree of conductivity. For example, the volume resistance of an AlTiC substrate used to manufacture a magnetic head is around 3×10⁻³ (Ω·cm), which makes it possible to carry out electrolytic plating by having electricity conducted to the plating seed layer 12 via the conductive parts 16.

When forming the conductive parts 16 on the substrate 10, the conductive parts 16 may be formed at appropriate positions on the surface of the substrate 10. Since a large number of products are normally fabricated on a single work when manufacturing a magnetic head or other electronic components, it is easy to form the conductive parts 16 in accordance with the arrangement of the individual formation regions of the products in regions that do not affect the products.

FIG. 2 is a diagram useful in explaining an example where magnetic heads are fabricated on the substrate 10. On the substrate 10, element regions A where the magnetic heads will be formed are arranged vertically and horizontally, with cutting regions that are each used to produce a slider when the substrate 10 is diced being formed between adjacent element regions. Accordingly, by forming the conductive parts 16 in such cutout regions, it is possible to form the conductive parts 16 without affecting the products.

In this way, when fabricating a large number of products, it is possible to provide one conductive part 16 for each individual element region or to provide one conductive part 16 for each group of a plurality of element regions. When a magnetic layer with a high specific resistance is used as the plating seed layer 12, the conductive parts 16 should be formed with a higher density, such as by forming one conductive part 16 per element region.

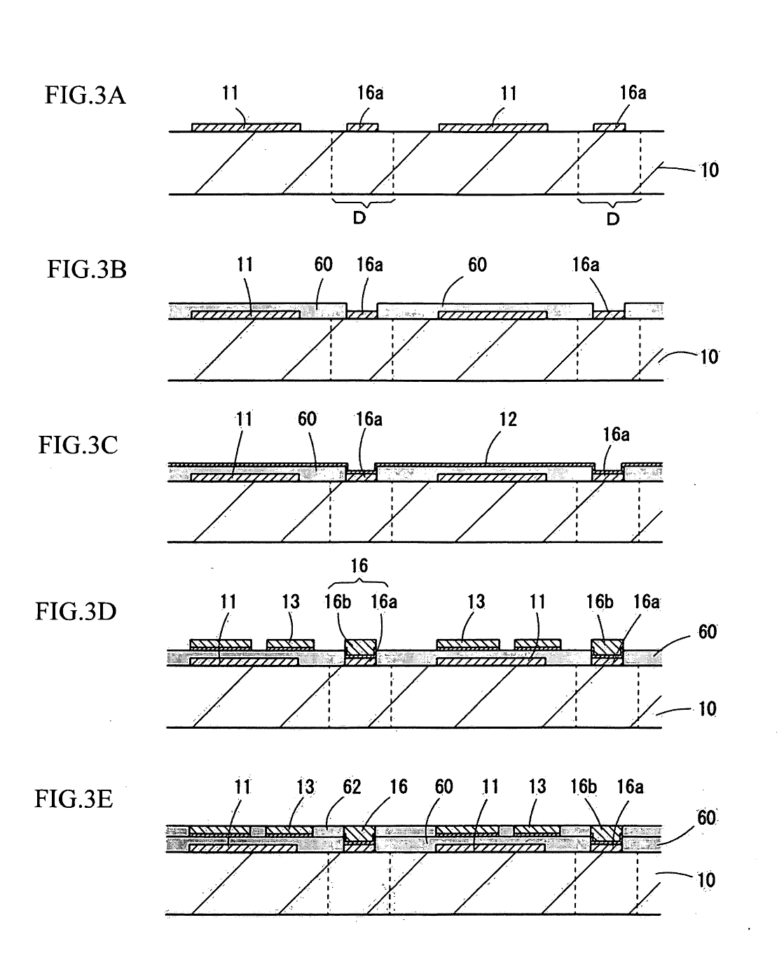

FIGS. 3A to 3E show an example of where a conductive layer is laminated while forming the conductive parts 16 on the substrate 10.

FIG. 3A shows a state where a first insulating layer 11 has been formed in a predetermined pattern on the substrate 10. The part D shown by broken lines in FIG. 3A shows a cutting region where the substrate 10 will be cut in a later process. When patterning the insulating layer 11, conductive parts 16a are formed in a pattern in alignment with the cutting regions D. The conductive parts 16a are composed of a magnetic layer, and are electrically connected to the substrate 10.

FIG. 3B shows a state where an insulating layer 60 has been formed on the surface of a work in the next process. When the insulating layer 60 is formed, a resist or the like is formed to cover the conductive parts 16a so that the conductive parts 16a do not become covered by the insulating layer 60.

FIG. 3C shows a state where the plating seed layer 12 has been formed on the surface of the work. The plating seed layer 12 is formed by a dry process such as sputtering or a wet process such as electroless copper plating. Since the surfaces of the conductive parts 16a are exposed from the insulating layer 60, the plating seed layer 12 conducts electricity to all of the conductive parts 16a formed on the substrate 10.

FIG. 3D shows a state where a second insulating layer 13 has been formed in a pattern with the plating seed layer 12 as a plating power supply layer. When the second insulating layer 13 is patterned, conductive parts 16b of a second layer are formed in alignment with the conductive parts 16a. By doing so, the conductive parts 16 that conduct electricity to the substrate 10 are constructed by the conductive parts 16a and 16b.

FIG. 3E shows a state where in a further process, an insulating layer 62 has been formed on the surface of the work and the surface of the insulating layer 62 has been ground to expose the surface of the second insulating layer 13 and the surfaces of the conductive parts 16b from the surface of the insulating layer 62. During the manufacturing process of a magnetic head, a process is carried out where the surface of the work is covered by an insulating layer and the surface of the work is then ground. By carrying out this kind of grinding process to expose the surfaces of the conductive parts 16, the plating seed layer and the conductive parts 16 can be electrically connected and the conductive parts 16 and a magnetic layer (conductive layer) formed as the next layer can be electrically connected.

In the manufacturing process of a magnetic head or the like, a magnetic layer and/or a conductive layer, and an insulating layer are formed with an extremely complex construction. In FIGS. 3A to 3E, a simplified construction has been shown for ease of understanding. Even when a conductive layer and an insulating layer are formed on top of one another in a complex manner, the fundamental method of manufacturing is the same as the process shown in FIGS. 3A to 3E, and by forming the conductive parts 16 with consideration to the electrical connections between the layers, it becomes possible to electrically connect each individual layer to the substrate and the plating seed layer via the conductive parts.

Also, the method of forming the conductive parts 16 described earlier is not limited to the manufacturing process of a magnetic head and can be applied in the same way to the manufacturing process of a multilayer wiring substrate used in a common electronic component.

In this way, when forming an insulating layer and a magnetic layer or conductive layer on top of one another on the substrate 10, by having electricity conducted through the conductive parts 16 and the substrate 10, it becomes possible to effectively suppress fluctuations in the potential of the plating seed layer via the conductive parts 16 and the substrate 10 and therefore possible to suppress fluctuations in the thickness of the plating. By doing so, it is possible to form the required pattern with high precision, so that the quality of products can be improved and fluctuations between products on the same work can be suppressed, thereby improving the yield of the products.

As shown in FIG. 3D, by providing the conductive parts 16 in the cutting regions where the work is cut, it is possible to avoid causing adverse effects on the manufactured products. There is also the advantage that it is possible to manufacture products without changing the layout rules for the element regions on a conventional substrate 10.

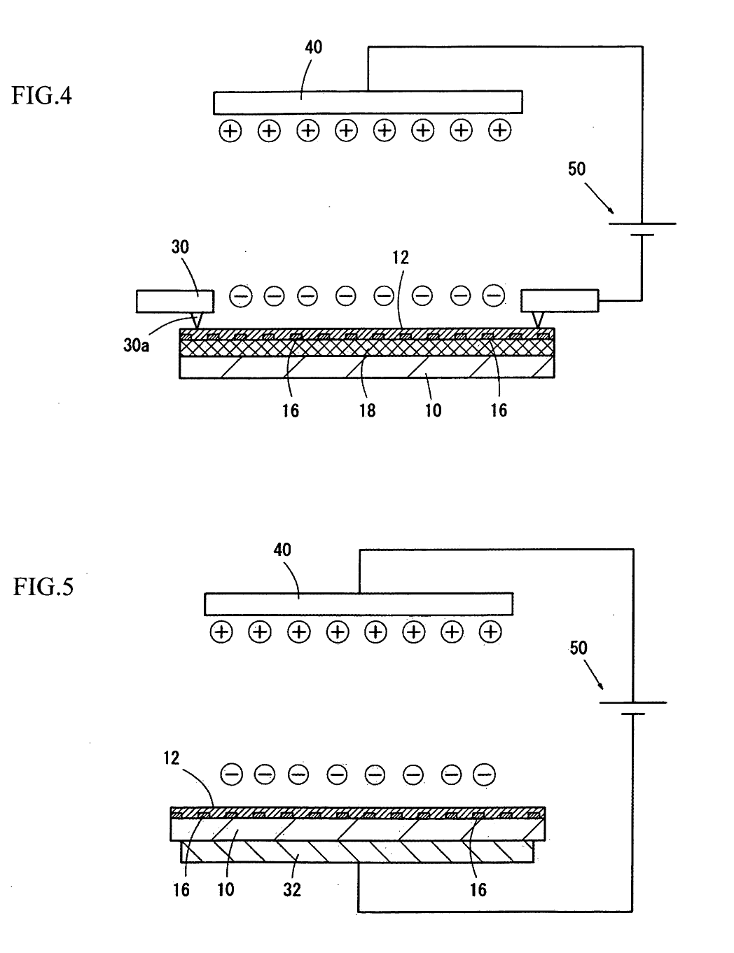

In the embodiment described above, to suppress fluctuations in the potential of the plating seed layer 12, there is a premise that the substrate 10 is formed of a resistor with fairly low resistance. When the substrate 10 is formed of a complete insulator, as shown in FIG. 4, it is effective to use a method where a resistor film 18 is formed as a resistor layer to cover the surface of the substrate 10 and to conduct electricity to the resistor film 18 via the conductive parts 16.

In this case, by having electricity conducted to the plating seed layer 12 and the resistor film 18 via the conductive parts 16, plating can be carried out without fluctuations being produced in the potential of the plating seed layer 12.

Note that the resistor film 18 is formed on the surface of the substrate 10 within a range that does not affect the characteristics and the like of the products.

### Second Embodiment

FIG. 5 shows a construction for a second embodiment of a plating method according to the present invention. The construction is the same as the construction in the first embodiment in that the work disposed on the negative electrode side is constructed so that electricity is conducted between the substrate 10 and the plating seed layer 12 via the conductive parts 16 formed on the surface of the substrate 10. Note that the substrate 10 is formed as a resistor that conducts electricity.

The construction in the present embodiment is characterized by carrying out plating with a plating contact 32 of the negative electrode that is electrically connected to the plating seed layer 12 in contact with the rear surface of the substrate 10.

In a conventional plating apparatus, as shown in FIG. 1, the plating contacts 30a of the negative electrode 30 are placed in direct contact with the plating seed layer 12 on the surface on which the plating seed layer 12 is formed, thereby placing the plating seed layer 12 at the negative electrode potential. On the other hand, when the plating contact 32 is disposed on the rear surface of the substrate 10 as in the present embodiment, it is possible to use the entire substrate as a region for forming products, which makes it possible to increase the used area of the substrate, even when a substrate of the same dimensions is used.

Note that although it is possible to carry out plating with the plating contact 32 disposed on the rear surface of the substrate 10 as in the present embodiment, this is dependent on the substrate 10 being conductive and on electricity being conducted from the substrate 10 to the plating seed layer 12 via the conductive parts 16. If the plating seed layer 12 is electrically insulated from the substrate 10 as in the conventional art, it will not be possible to have electricity conducted as in the present embodiment. Also, in the present embodiment, by uniformly disposing the conductive parts 16, which electrically connect the substrate 10 and the plating seed layer 12, on the surface of the substrate 10, there is the advantage that fluctuations in the distribution of the potential of the plating seed layer 12 during electrolytic plating can be prevented, thereby making it possible to make the plating thickness uniform.

The method according to the present invention can be used when carrying out plating using a plating seed layer and is not limited to the type of work being plated. As examples, it is also possible to apply the method when forming a wiring pattern by copper plating, when forming a magnetic layer by magnetic plating, and when carrying out protective plating such as nickel or gold plating on terminal parts. The shape of the work is also not limited to a disc-shaped substrate, and the method can be applied to a rectangular wiring substrate or the like. Aside from ceramic substrates, the method can be applied to semiconductor wafer substrates, resin substrates, and the like.

What is claimed is:

1. A method of carrying out plating on a substrate, comprising steps of:
forming an insulating layer, which includes conductive parts that conduct electricity to the substrate, on the substrate that is made of a resistor;
forming a plating seed layer, which conducts electricity to the substrate via the conductive parts, on the insulating layer; and
forming a plating film on the plating seed layer with the plating seed layer as a power supply layer.

2. A method of carrying out plating according to claim 1,
wherein a conductive layer is formed in a pattern on the substrate to form the conductive parts and the insulating layer is selectively formed on the conductive pattern.

3. A method of carrying out plating according to claim 1,
wherein plating is carried out by placing a plating contact of a negative electrode in contact with a rear surface of the substrate.

4. A method of carrying out plating according to claim 1,
wherein the conductive parts are formed corresponding to formation regions of products formed on a work.

5. A method of carrying out plating on a substrate, comprising steps of:
forming an insulating layer, which includes conductive parts that conduct electricity to a resistor layer formed on a surface of an insulating substrate, on the insulating substrate;
forming a plating seed layer, which conducts electricity to the resistor layer via the conductive parts, on the insulating layer; and
forming a plating film on the plating seed layer with the plating seed layer as a power supply layer.

6. A method of carrying out plating according to claim 5,
wherein plating is carried out by placing a plating contact of a negative electrode in contact with a rear surface of the resistor layer.

7. A method of carrying out plating according to claim 5,
wherein the conductive parts are formed corresponding to formation regions of products formed on a work.
